(19) United States
(12) Patent Application Publication
(10) Pub. No.: US 2010/0145887 A1
(43) Pub. Date: Jun. 10, 2010

(54) System and Method for the Achievement of the Energetic and Technological Self -Sufficiency of Sea and Inland Ports with the Full Exploitation of Port's Internal Resources (Zero Waste- Zero Energy System)

(75) Inventor: Marko Likon, Ankaran (SI)

Correspondence Address: Marko Likon;Mitja Grbec, Regentova 6, Ankaran, SI-6280, omitted

(73) Assignee: Insol Ltd., Ankaran (SI)

(21) Appl. No.: 12/331,465

(22) Filed: Dec. 10, 2008

(51) Int. Cl. G06Q 90/00

(52) U.S. Cl. 705/500

(57) ABSTRACT

System and method for the achievement of the energetic and technological self-sufficiency of sea and inland ports with regard energy (zero-energy) and water supply with the full and pollution free exploitation of the port's internal resources (zero waste). The system comprises of an innovative linking of existing technologies and of a method which allows sea and inland ports to be independent from external suppliers of electricity and water while at the same time it provides ports with an autonomous and pollution free system for disposing of generated wastes. This includes municipal solid and similar waste (MSW), technological waters, bilge waters; and optionally MSW generated by the local community. The system is formed by an Energy Distribution Center (EDC) and an optimal linkage of mass and energetic flows and known technologies comprising as a minimum a: 1) technology for substantial/energetic conversion of MSW with a positive energetic balance (AAD); (2) technology for substantial/energetic conversion of bilge water (BW) and contaminated plastics (RDF) to synthetic fuel or energy (G/P); (3) technology for treatment of municipal or industrial sewage (WWTP) and; (4) technology for conversion of sea and/or inland water to pot and industrial water (RO/UF). The system manages and distributes port's internal resources in a synergistic way to achieve their optimal utilization and the “zero waste- zero energy” (ZW-ZE) effect.

### CROSS-REFERENCE TO RELATED APPLICATIONS

Not applicable

### STATEMENT REGARDING FEDERALLY SPONSORED RESEARCH AND DEVELOPMENTS

Not applicable

### BACKGROUND OF THE INVENTION

1. Field of the Invention

The present invention relates to a system and method for the achievement of the energetic and technological self- sufficiency of sea and inland ports (zero energy) with the full and pollution free exploitation of port's internal resources (zero waste).

2. Related Prior Art

There are solutions for separate (stand- alone) technologies within the invented system but there are no known methods and systems which would allow sea and inland ports to achieve the “zero waste-zero energy” system by exploiting their internal resources with an optimal evaluation of mass and energetic flows and the linkage of existing technologies.

US Patent Application, No. US2008/0236042, published on Oct. 2, 2008 (Rural Municipal Waste-to-energy system and methods) describes a method and system for converting waste to energy which may enable smaller local municipalities, primarily in rural areas, to develop its own independent power supply, but it does not provide a solution for a “zero waste- zero energy system”, nor for the water supply and furthermore it is not applicable to ports.

3. Background of the Invention

Sea and inland ports are big consumer of energy and water and considerable generators of waste and greenhouse emissions. Ports mostly rely on the public infrastructure to satisfy their needs for energy and on the public waste management system for the disposal of their waste. Their wastes are in most cases landfiled with the accompanying environmental problems for local communities, particularly an increase in GHG emissions, a threat to ground waters and the shortening of the life cycle of public land fields. The energetic and technological dependency of sea and inland ports on the public infrastructure hinders the day to day functioning of the ports (logistical, energetic, ecological and related economic problems) and affects their development (expansion) plans. National legislations and international conventions requires ports to be equipped with waste receiving facility for bilge waters whose environmental and economical disposal represent an additional problem for ports systems and the nearby local municipalities. Ports systems tend to achieve a greater degree of self-sufficiency (autonomy) for their energetic and water supply through the exploitation of their internal resources, including the utilization of generated waste and the exploitation of various alternative sources of energies. The existing methods and known systems of technologies does not allow for the complete utilization of port's internal resources (zero-waste); at least not in a way which would allow ports to achieve self-sufficiency with regard the supply of energy and water and independency from external waste management systems. The proper choice of the linked technologies which are forming part of the new innovative “ZW-ZE” system (invention) and the proper evaluation of mass and energy flows ensures the optimal functioning of the linked technologies, the optimal utilization of the available port's internal resources and the achievement of thee “ZW-ZE” system. The claimed system and method is particularly suitable for multipurpose ports located close to urban areas.

### BRIEF SUMMARY OF THE INVENTION

Sea and inland port systems are big energy consumers and generators of energy rich waste. This is particularly true for multipurpose ports which are handling different types of cargo and produce different types of energy rich wastes. The position of ports beside water sources (ocean, rivers, lakes . . . ) and the big surface on which they are normally situated enables them to exploit different alternative energy sources (solar, wind, waves, tides, production of pot water from sea or river . . . ) while the nature of their principal activities permits them to exploit highly developed logistic and transport infrastructure.

The system and method described in this invention comprises of an innovative linkage of existing technologies and of an Energy Distribution Center (EDC) which allows for a synergistic effect and for the optimum utilization of port's internal energetic and raw materials resources (MSW, technological and bilge waters and optionally different types of alternative energies exploitable within the port area as solar energy, wind, waves, tides . . . ) with the aim to enable the port to become independent from the external suppliers of water and energy and from the external waste management systems (zero waste-zero energy system). The “zero waste-zero energy” system may be linked to the public water and electricity supply systems while wastes from the nearby local communities may be utilized within the port's own waste management system. This kind of energetic and technological interlink is beneficial for the port system (which has the possibility to sell the eventual surplus of electricity and water to the public networks and to get additional energy rich waste from the local community) as also for the local community (which could solve its waste management problems by handling wastes to the port and which could benefit from cheaper green electricity and water). However, such interlink is not a condition for the functioning of the “zero waste-zero energy” system.

### BRIEF DESCRIPTION OF THE SEVERAL VIEWS OF THE DRAWING

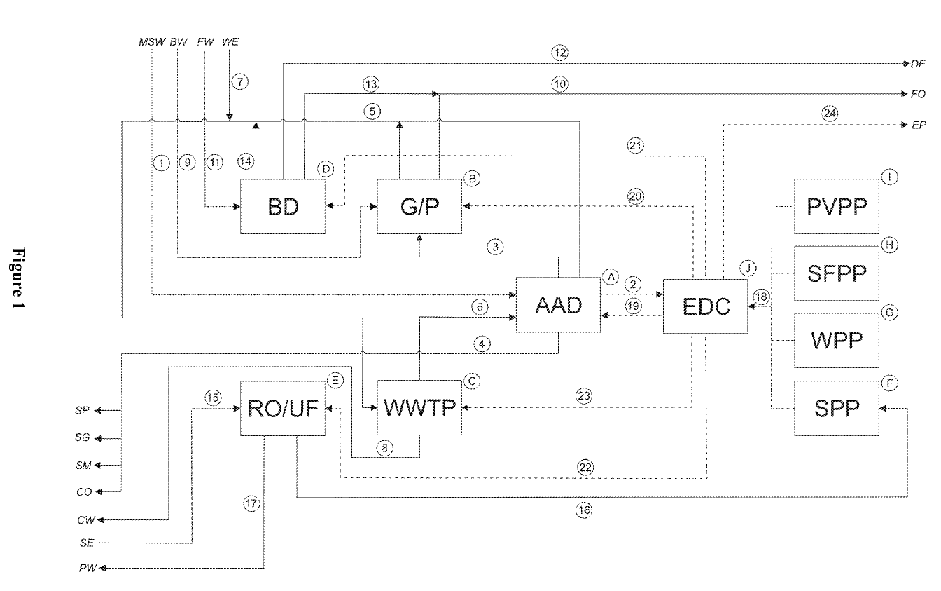

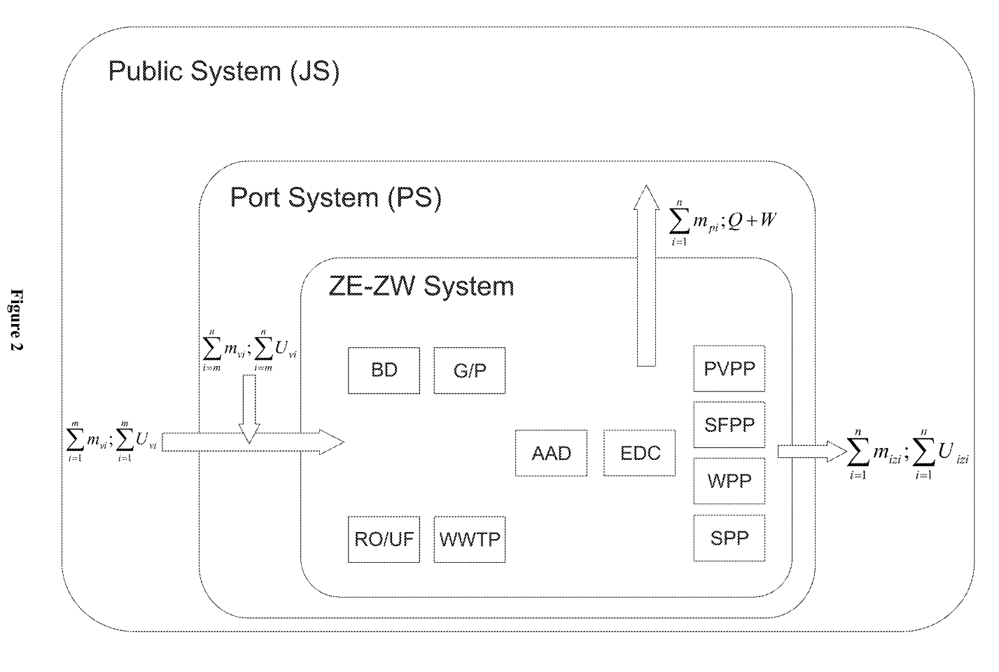

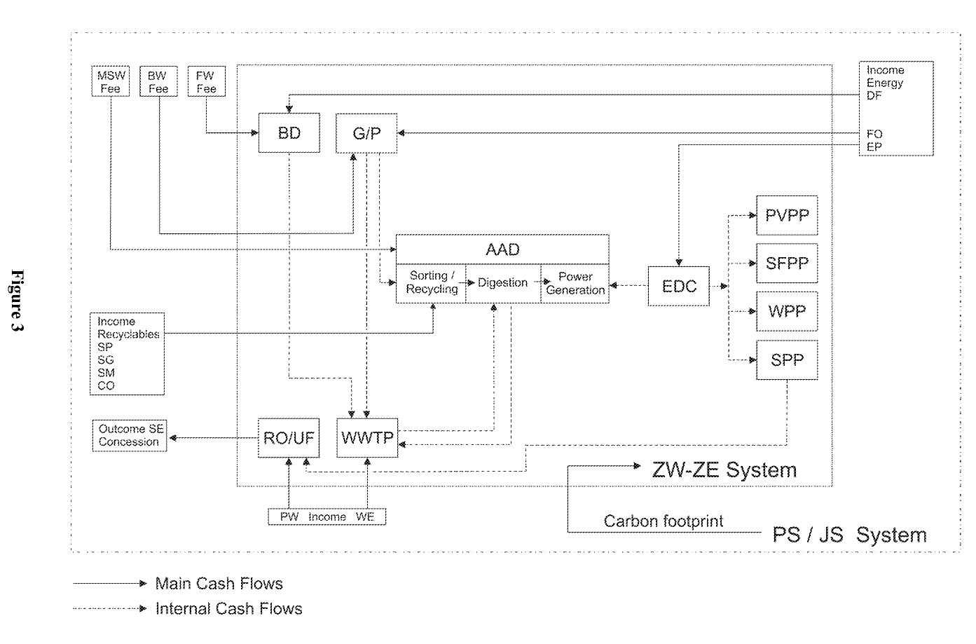

The schematic description (flow chart) of the system is shown on FIG. 1, the incorporation of the ZW-ZE system within the PS and JS and a description of the energy and mass flows is shown on FIG. 2, while the business method is shown on FIG. 3.

### DETAILED DESCRIPTION OF THE INVENTION

The purpose of the present invention is to provide an efficient system and method for the achievement of the energetic and technological self- sufficiency of sea and inland ports (zero-energy) by the full and pollution free exploitation of their internal resources, particularly by the full utilization of the generated waste within the port system (zero waste).

Internal port's resources comprises energy sources, materials which can be energetically or substantially exploited, the logistic and transport infrastructure of a certain port system and its strategic position beside water sources as seas, rivers or/and lakes. The energy sources of a port system comprise solar energy, hydro energy, wind energy and the energy of waves and tides. Substantial port sources are MSW, fat waste (FW), sea/sweat water (SW) and municipal or industrial sewage (WE). Hybrid substantial/energetic flow presents energy rich waste as bilge water (BW), biodegradable waste (BDW) and contaminated plastic (RDF) which is a by product of the MSW recycling process. An important internal port's source is also the highly developed logistic and transport infrastructure and its links with the public networks. Roads and pipelines enable an efficient transport, reservoirs and warehouses enable storage of the materials and products while available electrical installation and short isolated pipelines enable an efficient distribution of electricity and heat within the port system.

Technologies forming part of the “ZW-ZE” system are divided in two groups. Main technologies are technologies which are linked in the system and are essential for its establishment and functioning and include: (1) technology for substantial/energetic conversion of MSW with a positive energetic balance (AAD); (2) technology for substantial/energetic conversion of bilge water (BW) and contaminated plastics (RDF) to synthetic fuel or energy (G/P) and, (3) technology for treatment of municipal or industrial sewage (WWTP) and; (4) technology for conversion of sea and/or water to pot and industrial water trough desalination processes and/or purification (RO/UF). Optional technologies are not essential for the establishment and functioning of the ZW-ZE system and their availability and exploitation capacity depends upon the characteristics and location of a particular sea or inland port. Their inclusion in the system may optimize the functioning of the system. They comprise (among others): (1) technology for converting fat wastes (FT) to biodiesel (BD); (2) technology for the supercritical extraction of particular types of waste in order to get the necessary components for the production of active components for pharmaceutical products, and the following pretreatment of remaining waste for digestion in AAD; (3) technology for the electrolytic decomposition (ESW) of SW to components and conversion of them into electricity or used as co fuel; (4) technology for production of electricity by exploiting salt concentration gradient between brine from RO and SW (SPP); (5) technology for the production of electricity through the use of wind power (WPP); (6) technology for the conversion of the hydrodynamic energy of water (water currents, waves and tide energy) to electricity (SFPP); (7) photovoltaic technology to convert solar energy into electricity (PVPP); (8) technology for the pelletisation of compost and its exploitation as biomass.

A condition for the proper functioning of the ZW-ZE system is an appropriate selection of technologies and an optimal evaluation of mass and energetic flows which are divided to main, intermediate and optional. Main mass and energetic flows represent an indispensable condition for functioning of the ZW-ZE system, intermediate mass flows are formed as a consequence of the functioning of the linked technologies and are necessary for the proper functioning of the system; (3) optional mass and energetic flows are used for the optimization of the basic ZW-ZE system and their application depends upon the characteristics and needs of a particular port's system.

Main mass flows are flows of raw materials and products (FIG. 1) which are a condition for the functioning of the ZW-ZE system and comprises: (1) the flows of MSW from the port system and optionally from the public system 1; (2) flow of bilge waters from the port system 9; (3) flow of industrial sewages from ports system and optionally municipal sewage from public system 7; (3) mass flow of secondary raw materials from MSW sorting process (paper, glass, plastic, metals etc.) 4; (4) mass flow of compost from substantial/energetic processing of MSW 4. Intermediate mass flows are defined as flows which are formed as a consequence of the conversion of the main mass flows due to the functioning of the linked technologies and they comprise: (1) mass flows of unprocessed fractions of MSW (plastic for example) from AAD into G/P 3; (2) mass flow of biological sludge from biological WWTP (mass flow is neglect in case of using non biological waste water treatment, membrane technologies for example) into AAD 6; (3) mass flow of technological waste water from AAD to WWTP 5. Optional mass flows are flows which are not necessary for the functioning of the ZW-ZE system; they represent an improvement/upgrading of the system and they comprise inter alia: (i) flows of fat waste from port and optional from public system 11; (3) mass flow of brine from desalination process into salt power plant 16.

Overall energy flows of the ZW-ZE system are energy flows formed by internal and output energy flows (FIG. 1). Internal energy flows are energy flows produced by the system itself used for the optimal operation of the various technologies linked within the ZW-ZE system; they comprise the internal flows of electricity and heat 2, 18, 19, 20, 21, 22, 23. Internal energy flows are also energy flows generated from the various alternative sources of energy within the port system (solar energy, wind energy, sea tide energy, energy of the waves, energy of salt concentration gradient . . . ) whose exploitation depends upon the location of the a particular port system, and they are merged into energy flow 18. Output energy flows are energy flows generated by the ZW-ZE system and used for the energetic supply of the port system (self sufficient port) and they are defined as: (i) the output flow of electricity which is to be distributed to the to port or/and public system; (ii) the output flow of heat which is to be distributed to the port system (heating, drying, other technological processes . . . ); (iii.) output of energy in the form of rich mass flows as synthetic fuel or biodiesel.

Mass and energy flows are distributed inside closed circles within the ZW- ZE system in order to fulfill the following criteria:
1. Positive energy flows from ZW-ZE system into the ports system to ensure the energetic self sufficiency of the port system

|Q+W|ₚₛ≧Σᵢ₌₁ⁿΔEₙ; where Eᵢ₌₁ⁿ ΔEₙ represents the sum of energy needed within the PS; |Q+W|ₚₛ is a positive energy flow from the ZW-ZE system into the port system. Equation 1.
2. >>Zero waste<<condition

Σᵢ₌₁ⁿ mᵥᵢ=Σᵢ₌₁ⁿ mₚᵢ+Σᵢ₌₁ⁿ m_{izi} in lim_{n→0}Σᵢ₌₁ⁿ(m_{izi})=0, where Σᵢ₌₁ⁿ mᵥᵢ represents the sum of input mass flows, Σᵢ₌₁ⁿ mₚᵢ the sum of used mass flows within the ZE-ZW system, Σᵢ₌₁ⁿ m_{izi} the sum of output mass flows. Equation 2.
3. >>Zero energy<<condition

Σᵢ₌₁ⁿ Uᵥᵢ=Q_{ZE}+W_{ZE}+Σᵢ₌₁ⁿ U_{izi} and lim_{n→0}(Σᵢ₌₁ⁿ U_{izi})=0, where Σᵢ₌₁ⁿUᵥᵢ represent the sum of input energy flows, Q+W the sum of generated/used energy flows and work within the ZW-ZE system, Σᵢ₌₁ⁿ U_{izi} the sum of output energy flows. Equation 3.

(Q+W)_{ZE}=(Q+W)ₚ+(Q+W)ₛₚ in lim (Q+W)ₚ=0, where (Q+W)ₚ represents the energy and work used for the maintenance of the ZW-ZE system, (Q+W)ₛₚ energy and work transfer into the PS which must be positive. Equation 4.

Σᵢ₌₁ⁿUᵥᵢ=(Q+W)ₛₚ Equation 5.

Mass flows are transferred inside closed circles in a way which allows the full exploitation of the existing port infrastructure and the optimization of the logistics and transport processes. The environmental impact of the linked technologies is substantially lower compared non-connected self standing technologies. The ZW-ZE system substantially improves the economic performance of the port system, due to substantial cost reduction in the fields of ecology and energy, due to the decreasing costs of waste management coupled with the decrease in greenhouse emissions, decreasing costs of traffic and transportation and due to the possibility to exploit and use different alternative sources of energy. The ZW-ZE system also improves the social environment within which the port is operating, because of the new high value jobs available.

### 1. Detailed Description of Drawings

The schematic description of the system is shown on FIG. 1, the incorporation of the ZW-ZE system within the PS and JS and a description of the energy and mass flows is shown on FIG. 2, while the business method is shown on FIG. 3. The central point of the ZW-ZE system is the EDC where optimization of mass and energy flows is carried out based on real time information from different sub-system.

The main internal source of the system is mass flow MSW 1 from the PS and optionally from the JS. Biological degradable fraction is converted with a hybrid wet one-stage aerobic/anaerobic process within the AAD subsystem to biogas which is used for electricity production 2. Depending on the composition of MSW, and after the process of sorting within the AAD subsystem, an intermediate mass flow of mixed plastics RDF 3 is formed. Due to its dirtiness the later does not represent a source of secondary raw materials but it is as intermediate mass flow of energy rich fraction which is lead into G/P B subsystem for the conversion of plastics and bilge oils into synthetic fuels. During the MSW presorting process a mass flow of secondary raw materials 4 is produced composed by recycled plastic SP, recycled glass SG, recycled metals SM and after the BWD biodegradation process also compost CO. The quantity of produced compost within mass flow 3 can be substantially reduced by its conversion into burning pellets or biomass. By the inclusion of special stoves for the burning of biomass within the system, particularly in the presence of a mass flow of oxygen as described in paragraph 11, it is possible to produce additional heat energy and to decrease the mass flow of compost into the public system (JS). Polluted technological waters are formed during AAD operations, which are collected and directed to WWWTP C. A tipping fee may be charged to PS for the recycling of MSW and industrial waste produced within the port system and optionally to the local communities for MSW generated outside the PS (JS). Recycled plastic (SP), recycled glass (SG) and recycling metal (SM) separated on the AAD sorting line can be sold. Compost (CO) produced within AAD may be sold to the PS or external users (also as pellets or biomass). Produced biogas is converted to electricity to be used by the ZW-ZE energy system while the surplus may be sold to the PS and optionally to JS.

The intermediate mass flow of RDF formed within AAD A is merged in subsystem G/P B with bilge waters BW 9, which are an industrial waste generated within PS. The common mass flow is converted in subsystem G/P into synthetic fuels FO 10. The G/P subsystem is based on catalytic decomposition of olefins and bilge oils to synthetic gas which is converted to fuel oil. Waste water produced within subsystem G/P are collected within the mass flow of waste water 5 and lead to WWTP for cleaning. A tipping fee may be charged to the PS for the recycling of BW generated within the PS. The produced synthetic fuels are sold to the port system or optionally to JS.

WWTP C is an installation for industrial and municipal sewage treatment. As a result of the biological treatment, an intermediate waste flow of biological sludge 6 is formed which is used as technological water in AAD process in order to accelerate the decaying of MSW bio waste fraction. WWTP subsystem serves as central waste water treatment plant for the purpose of collecting and cleaning the industrial waste water from the ZW-ZE system; plus the waste water generated within the port system and optionally by the waste waters from the public sewage system WE 7. The output mass flow from WWTP subsystem is represented by the flow of clean technological water CW 8 which can be used inside the PS system for the purposes of dust prevention, wetting of road infrastructure and different types of cargoes (ex. coal); cooling of warehouses (reservoirs), for the cleaning of working and public surfaces, watering of plants, fire extinguishing purposes. A tipping fee may be charged for treatment of WE from PS or JS.

The production of pot water is carried out in subsystem RO/UF E based on membrane technologies. Part of the pot water flow PW 15 is consumed inside ZW-ZE system, while the majority of water is transported to PS and optionally to the JS. An internal mass flow is represented by the flow of brine 16, which is directed towards the subsystem for the production of electricity (SPP F). Produced pot water (PW) is sold to PS and optionally JS. The revenue is represented by the difference between the price of PW and the cost of the concession for the exploitation of SE.

The production of electricity is undertaken within the energetic concatenation of linked technologies PVPP I, SFPP H, WPP G, SPP F. The later exploit the alternative (natural) sources of energy whose type and amount is conditioned by the characteristic of the port system.
i. The location of the port, particularly the wideness of its area and the available surface on its infrastructure (particularly roof surface) allows for the exploitation of considerable amounts of solar energy. The produced electricity is distributed through EPD J into the system.
ii. In case of favorable conditions for the exploitation of the wind-energy, there is a possibility to establish a subsystem WPP G formed by fields of windmills connected to electro-generators. The windmill fields may be located on shore or on the sea within the port area, while there is also the possibility to install micro wind mills. The produced energy is then distributed trough EDC J into the system.
iii. The location of port systems beside water sources allows the exploitation of different types of hydro energy, as for example the energy of the waves, tide, sea currents or river streams within subsystems SFPP H. The produced electricity is then distributed via EPD J into the system.
iv. The production of energy generated by the difference of the salt concentration gradient of brine contained in the internal flow 16 and salt water is undertaken within subsystem SPP F. The produced electricity is then transferred through EPD to the system.
v. Depending on the energy surplus the technology for the electrolysis of sea water SW to hydrogen and oxygen will be installed.

The produced electricity from a combination of mentioned sources of alternative energies is then distributed through EDC, which is an integral part of the ZW-ZE system. EDC receives energy through the energetic flow 2 and 18, and then redistributes it throughout the system depending on individual subsystems AAD 19, G/P 20, BD 21, RO/UF 22, WWTP 23 etc. energetic needs. The surplus of electricity is sold to PS and optionally to JS. Internal heat flow is exchanged directly between generators (AAD, G/P, PVPP) of heat energy and users (BD, RO/UF, WWTP, etc.) of the later on the basis of information supplied by EDC. The surplus of energy 23 is then transferred directly trough EDC to the PS and optional to JS. The surplus of heat may be sold to PS and optionally to JS. A carbon footprint may be sold to interested market-PS/JS.

Internal port sources are often also wastes with high fat content FW, as for example agricultural and food products 11. They are converted into biodiesel in subsystem BD D. To ensure the undisturbed flow of raw materials and other reagents, it is necessary to use the port logistic infrastructure, as reservoirs, pipelines etc. and transportation infrastructure as maritime transport, road transport, balances etc. The main product of subsystem BD is biodiesel DF 12 while the side product is glycerol 13, which can be sold on the market as a standalone product or it can be use as synthetic fuel FO 10. Waste waters generated in subsystem BD are directed to mass flow of waste water 5 and lead to WWTP for cleaning. A tipping fee may be charged to PS and optionally to the JS for the recycling of fat agricultural and food waste FW generated within PS. DF is sold to PS or JS (See FIG. 3).

Other technologies may be included within the system which may serve for an efficient pretreatment of MSW before its final conversion in AAD. One example is represented by the technology for the supercritical extraction of olive and grape skins, remnants of cereals, coffee, cocoa and other agricultural product (paprika, onion, etc.), with the aim of producing of the bioactive macromolecules, as for example flavonoids. The technology serves for the generation of high added value extracts for the pharmaceutical industry and as a pretreatment of the waste with the aim of a more efficient degradation, and as a aid or/abyss for a more valuable utilization of carbon dioxide. A tipping fee may be charged to JS for the recycling of different waste containing bioactive substances. Extracted substances are sold to interested market.

The described cash flows are the main cash flows between ZW-ZE and PS/JS systems. Internal cash flows within ZW-ZE system are cash flows necessary for optimal functioning of ZW-ZE system. The aim of the proposed model is to optimize the internal cash flows regarding main cash flows in order to maximize revenue.

1. System and method for the achievement of the energetic and technological self- sufficiency of sea and inland ports with the full and pollution free exploitation of port's internal resources (zero waste-zero energy system) comprising the steps of:
a.) Establishing an Energy Distribution Center (EDC) and linking it with: (i) technology for: substantial/energetic conversion of MSW with a positive energetic balance (AAD); (ii) technology for substantial/energetic conversion of bilge water (BW) and contaminated plastics (RDF) to synthetic fuel or energy (G/P); (iii) technology for the treatment of municipal or industrial sewage (WWTP) and; (iv) technology for the production of pot water from sea or river (lake); and optionally linking it with one or more technologies for the production of alternative sources of energies as: (v) photovoltaic technology for converting solar energy into electricity (PVPP); (vi) technology for the production of electricity through the use of wind power (WPP); (vii) technology for the conversion of the hydrodynamic energy of water (tide energy, flow energy) to electricity (SFPP); (viii) technology for the electrolytic decomposition (ESW) of SW to elements and conversion of them to electricity and as co-fuel; (ix) technology for converting salt concentration gradient between brine from RO and SW to electricity (SPP); (x) technology for the pelletisation of the compost and its exploitation., in an amount and manner necessary to achieve the zero waste-zero energy system.
(b) Leading the mass flows 1 into sub-system A and converting it into mass flows 3 containing energy rich material, mass flows 4 containing recyclables and energetic flow 2; joining the mass flow 9 and mass flow 3 into sub-system B and converting it to fuel 10; leading the mass flow 15 into sub-system E and separating raw water into pot water 17 and brine 16 to be optionally transported into subsystem F; leading mass flows 5 and 7 into sub system C and converting it into mass flows 6 and 8.
(c) Joining the energy flows produced into one or more of sub-systems F, G, H, I into a single energy flow 18 and leading it, together with energy flow 2, into sub-system J which redistributes the collected energy into internal energy flows 19, 20, 21, 22, 23 and the external energy flow 24 in a way which ensures at all times the optimum utilization of internal energy flows 20, 21, 22, 23 formed by electricity and heat.
d.) Generating a source of revenue for the operator of the ZW-ZE system and/or the operator of the port by selling one or more of the mentioned products of the ZW-ZE system:
(i) recycled plastic (SP), recycled glass (SG) and recycling metal (SM) to JS,
ii.) produced compost to the JS,
iii) produced/recycled synthetic fuels to PS or JS,
iv) produced CW to PS,
v.) produced pot water to PS or JS,
vi) surplus of produced electricity and optionally heat to PS or JS,
j.) carbon footprint generated within the system to PS or JS.

2. The system and method of claim 1 further comprising the steps of:
a) Linking the technology for conversion of fat wastes (FT) to biodiesel (BD).
b.) Leading the mass flow 11 into sub-systems (D) and converting it to DF 12 and glycerol 13.
c) Selling the produced DF and/or glycerol to PS or JS.

3. The system and method of claim 1 and optionally 2 further comprising the steps of:
a.) Linking the technology for the supercritical extraction of particular types of waste in order to get the necessary components for the production of active components for pharmaceutical products and to obtain the pre- treatment of remaining waste for digestion in AAD;
(b) selling the extracted substances to interested markets (JS).

4. The system and method of claim 1 and optionally 2 and 3 further comprising one or more of the following steps:
a.) charging a tipping fee to the PS or JS for the recycling of MSW and industrial waste,
b.) charging a tipping fee to the port(s) for the recycling of BW generated within the port,
c.) charging a tipping fee to PS or JS for the treatment of WE;
d.) charging a tipping to PS or JS for the recycling of fat agricultural and food waste;
e.) charging a tipping fee to the JS for the recycling of different waste containing bioactive substances.
